(19) United States
(12) Patent Application Publication
(10) Pub. No.: US 2019/0033582 A1
(43) Pub. Date: Jan. 31, 2019

(54) EMBEDDED SENSOR IN A HEADS-UP DISPLAY (HUD) PANEL

(71) Applicants: Benoit Chauveau, Van Buren Township, MI (US); Thierry Acas, Van Buren Township, MI (US)

(72) Inventors: Benoit Chauveau, Van Buren Township, MI (US); Thierry Acas, Van Buren Township, MI (US)

(21) Appl. No.: 15/664,330

(22) Filed: Jul. 31, 2017

(51) Int. Cl. G02B 27/01; F21V 8/00; G09G 3/00; G01J 1/42

(52) U.S. Cl. CPC G02B 27/0101; G02B 6/0075; G01J 1/42; G02B 6/0033; G09G 3/002

(57) ABSTRACT

Disclosed herein are devices and systems for implementing an embedded light sensor in a heads-up display (HUD) for adjusting luminance through sensed information from the embedded light sensor. Employing the concepts disclosed herein, the devices and systems may effectively record information, via the light sensor, and automatically adjust luminance of the content being displayed on the HUD.

### BACKGROUND

Displays are employed to convey digital information via a lighted platform. The displays are installed in a variety of contexts and environments, such as televisions, advertisements, personal computing devices, and more commonly in recent times, in vehicles.

The standard display assembly includes display driving logic with various instructions as to the patterns to communicate to an array of lighting elements. The display driving logic communicates signals that instruct which of the lighting elements to turn on, and essentially light up to a corresponding intensity and color (if available). The display assembly may be incorporated with various interface devices, such as keyboards, pointers, gaze trackers, head trackers, eye trackers, touch screens, and the like.

The displays are usually cased with transparent substances, such as lenses, that allow light being illuminated to be projected to the viewer's eyes. A surface of the lens faces the viewer of the display, and thus, implementers provide different shapes, sizes, and types based on an implementers preference. Further, different locations and such may necessitate the lens to be a specific type and shape.

In recent years, displays in vehicles have been employed using a head-up display (HUD). A HUD is a display intended to be in front of a viewer (for example, the windscreen area of a vehicle), and allows the viewer to see content through the windscreen and still see the landscape behind it.

However, because of the implementation mentioned above, the lighting conditions in the environment may vary. For example, if the present weather is overcast, the lighting may be dark. Conversely, if the present weather is sunny and clear, the lighting may be bright. In either case, the content being projected onto the HUD may be adjusted accordingly. A HUD implementation may be provided with a light sensor, the sensor detecting the current light condition, and effectively being employed to adjust the luminance of the content being presented on the HUD.

One such implementation is shown in FIG. 1. FIG. 1 illustrates a conventional HUD 150 implementation employing a sensor 160. The conventional HUD 150 shown may be any combiner HUD implemented in a vehicle. The HUD 150 includes a housing portion 151 and a blade 155 mechanically affixed to the housing portion 151, the blade 155 (transparent) being employed to display content. The blade 155 extends in a direction perpendicular to the housing portion 151.

The viewer 100 views, via the viewer 100's eyes 101, the blade 155. Thus, as content (virtual image 103) is displayed behind the blade 155, the viewer 100 via the optical axis 102, is capable of seeing the content/virtual image 103 while also looking through the windshield implemented in a vehicle.

The HUD 100 implementation in FIG. 1 also includes a sensor 160. As shown in FIG. 1, the sensor 160 is disposed on a surface of the housing portion 151 on which the blade 155 is attached to.

The sensor 160 is capable of detecting light through the field of detection 161. As illustrated in FIG. 1, the field of detection 161 does not overlap with the virtual image 103. The consequence of such is that the environmental conditions (or light sensed) by the sensor 160 is not capable of detecting the light affecting the virtual image 103.

FIG. 2 illustrates another conventional HUD 150 implementation employing a sensor 160. As shown in FIG. 2, a similar HUD 150 as depicted in FIG. 1 is provided. However, the sensor 160 is now in a different portion of the HUD 150's housing portion 151, and specifically in between the blade 155 and a part of the housing portion 151 away from the viewer 100.

Also shown in FIG. 2 is a windshield 120, which would be implemented in the front of a vehicle. As most windshields, such as windshield 120, are implemented with a dark silk print screen (due to regulations and other aesthetical demands), the field of detection 162 associated with sensor 160 is also obscured. Thus, employing the sensor 160 in the configuration shown in FIG. 2 is also effectively frustrated.

### SUMMARY

The following description relates to providing a system, method, and device for implementing a heads-up display (HUD) with a light sensor. Exemplary embodiments may also be directed to any of the system, the method, or an application disclosed herein, and the subsequent implementation in a vehicle application with a HUD situated in or around a front windshield.

The aspects disclosed herein are directed to an embedded sensor in a heads-up display (HUD). The HUD includes a light guide situated in the HUD, the light guide formed by introducing a reflective surface on a back portion of a transparent panel, the reflective surface being angled at a front facing surface and towards a surface perpendicular to the HUD; and a light sensor disposed on the surface perpendicular to the HUD.

Additional features of the invention will be set forth in the description which follows, and in part will be apparent from the description, or may be learned by practice of the invention.

It is to be understood that both the foregoing general description and the following detailed description are exemplary and explanatory and are intended to provide further explanation of the invention as claimed. Other features and aspects will be apparent from the following detailed description, the drawings, and the claims.

### DESCRIPTION OF THE DRAWINGS

The detailed description refers to the following drawings, in which like numerals refer to like items, and in which:

FIG. 1 illustrates an example of a head-up display (HUD) implementation with a sensor according to a first conventional implementation;

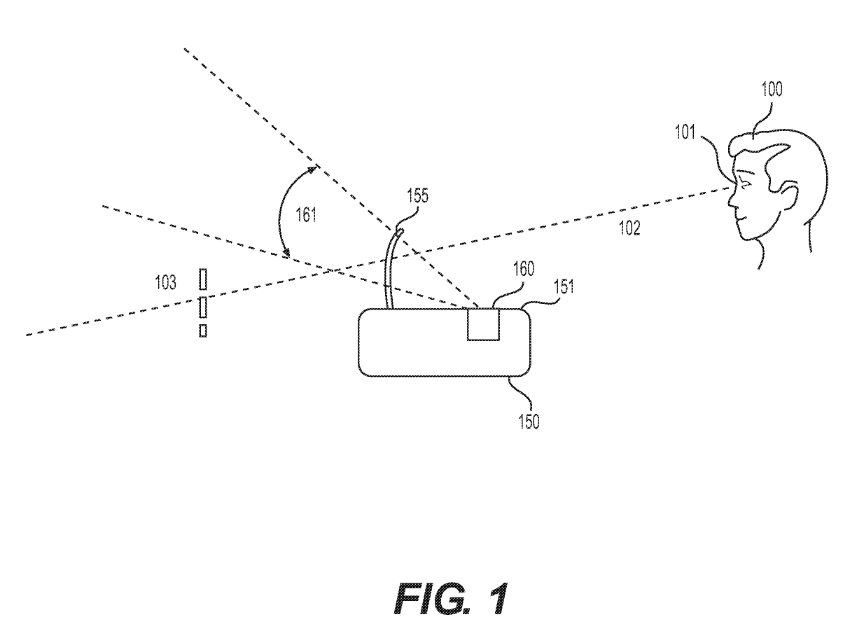

FIG. 2 illustrates an example of a HUD implementation with a sensor according to a second conventional implementation;

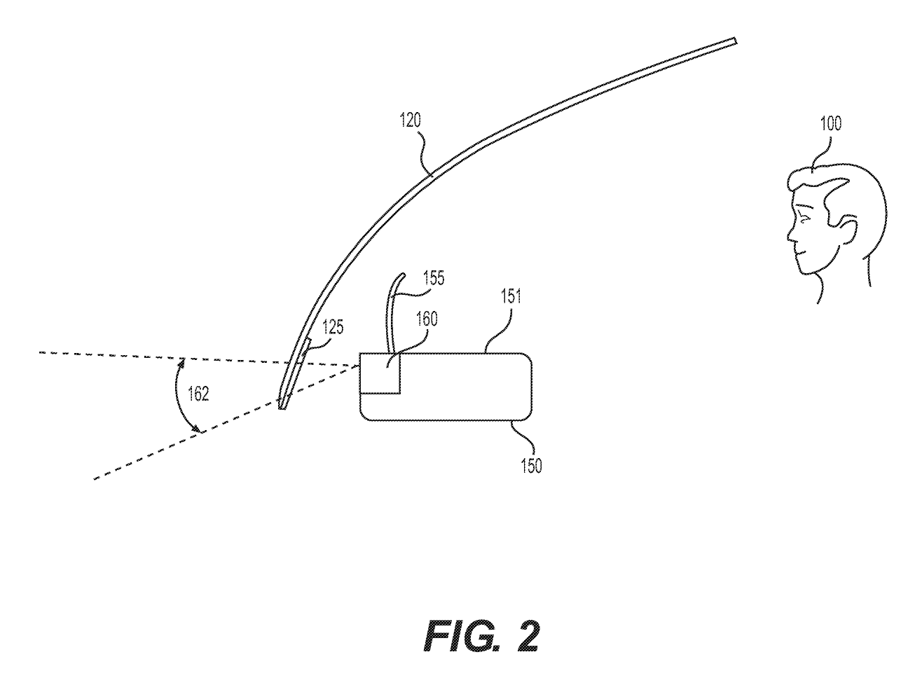

FIGS. 3A and 3B illustrate a blade view exemplifying a blade for a HUD without and with the aspects according to an exemplary embodiment of the disclosed invention;

FIGS. 4A and 4B illustrate a side-view of the HUD with a sensor integrated according to the exemplary embodiment; and

FIG. 5 illustrates the advantages of employing the implementation shown in FIGS. 4A-4B.

### DETAILED DESCRIPTION

The invention is described more fully hereinafter with references to the accompanying drawings, in which exemplary embodiments of the invention are shown. This invention may, however, be embodied in many different forms and should not be construed as limited to the embodiments set forth herein. Rather, these exemplary embodiments are provided so that this disclosure is thorough, and will fully convey the scope of the invention to those skilled in the art. It will be understood that for the purposes of this disclosure, “at least one of each” will be interpreted to mean any combination the enumerated elements following the respective language, including combination of multiples of the enumerated elements. For example, “at least one of X, Y, and Z” will be construed to mean X only, Y only, Z only, or any combination of two or more items X, Y, and Z (e.g. XYZ, XZ, YZ, X). Throughout the drawings and the detailed description, unless otherwise described, the same drawing reference numerals are understood to refer to the same elements, features, and structures. The relative size and depiction of these elements may be exaggerated for clarity, illustration, and convenience.

In conventional implementations of the heads-up display (HUD) with an integrated light sensor, the field of detection of the content is rendered not effective due to the limitations explained in the Background section. Thus, implementing a robust illumination adjustment system has not been achieved.

Disclosed herein are implementations for a system for integrating a HUD with a light sensor. By employing the aspects disclosed herein and the specific configurations and placement of the light sensor described in this disclosure, the field of detection is oriented in a manner that corresponds to the field of view of a viewer of a HUD.

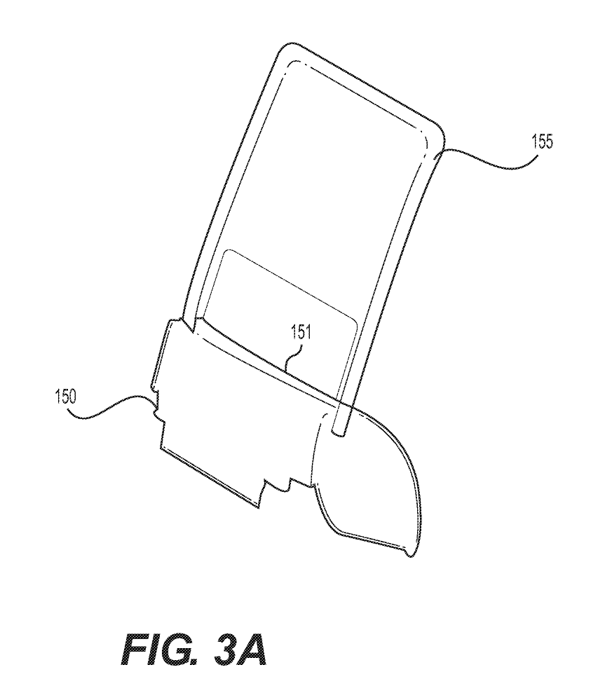

FIGS. 3(a) and (b) illustrate an example of HUD 150 incorporating an embedded light sensor. Referring to FIG. 3(a), the HUD 150 is shown without the embedded light sensor. As shown, the HUD 150 includes a housing portion 151 and a HUD panel 155.

FIG. 3(b) illustrates a back-view of the HUD 150, and with the modifications associated with embedding a light sensor according to the aspects disclosed herein. Specifically, a light guide 300 is introduced at the junction of the housing portion 151 with the HUD panel 155. This light guide 300 allows light associated with the view of the HUD panel 155 to be collected and distributed to a light sensor 310.

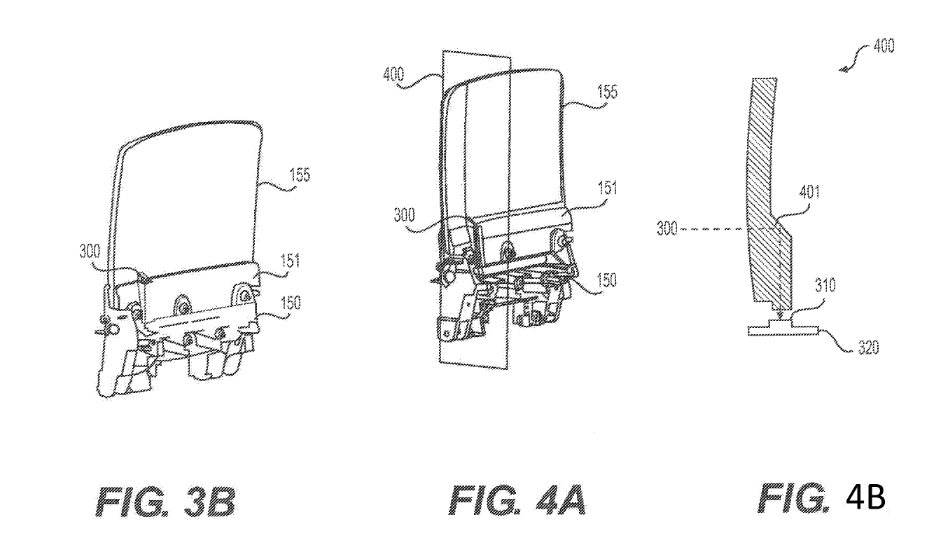

FIGS. 4(a) and (b) illustrate the application of light guide 300 in greater detail. Specifically, in FIG. 4(a), a highlighted planar portion 400 is demarcated. This highlighted planar portion 400 is shown in greater detail with the side-view illustrated in FIG. 4(b).

Specifically, the light guide 300 creates a light path as shown. The HUD panel is provided 155 with a reflective surface 401 that directs light towards a light sensor 310, the light sensor 310 being affixed to an electronic board (for example PCB) electrically coupled to a luminance adjustment system.

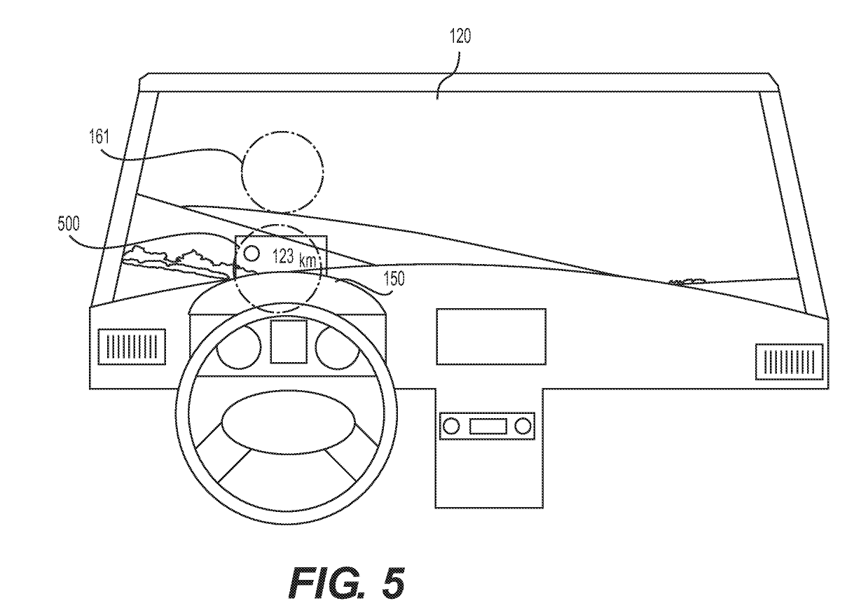

FIG. 5 illustrates the advantages of employing the aspects disclosed herein. As shown, the HUD 150 is implemented and employed in the front portion 120 of a vehicle. In the conventional implementation, the light sensor is only capable of capturing the field of detection 161.

Employing the aspects disclosed herein, and specifically the implementation described in FIGS. 4(a) and (b), the light sensor is now capable of capturing the field of detection 500. As shown, the field of detection 500 significantly overlaps the HUD 150, and specifically the portion of the HUD 150 being relied upon to display content.

As a person skilled in the art will readily appreciate, the above description is meant as an illustration of implementation of the principles this invention. This description is not intended to limit the scope or application of this invention in that the invention is susceptible to modification, variation and change, without departing from spirit of this invention, as defined in the following claims.

We claim:

1. An embedded sensor in a heads-up display (HUD), comprising:
a light guide situated in the HUD, the light guide formed by introducing a reflective surface on a back portion of a transparent panel, the reflective surface being angled at a front facing surface and towards a surface perpendicular to the HUD; and
a light sensor disposed on the surface perpendicular to the HUD.

2. The embedded sensor according to claim 1, wherein the light sensor is electrically coupled to a luminance adjustment system.

3. The embedded system according to claim 1, wherein:
the HUD includes a housing portion, the housing portion being mechanically affixed to the transparent panel, and
the reflective panel being introduced at the portion in which the transparent panel is exposed to a front windshield.

4. A heads-up display (HUD), comprising:
a transparent panel;
a housing portion, the housing portion mechanically affixed to the transparent panel;
a light guide situated in the panel, the light guide formed by introducing a reflective surface on a back portion of the HUD, the reflective surface being angled at a front facing surface and towards a surface perpendicular to the HUD; and
a light sensor disposed on the surface perpendicular to the HUD,
wherein the reflective surface is introduced at a portion of the transparent panel not covered by the housing portion.

5. A system for luminance adjustment, comprising:
a heads-up display (HUD) including a transparent panel and a housing portion;
a light guide introduced in the transparent panel; and
a light sensor disposed on a surface perpendicular to the transparent panel, wherein the light sensor is electrically coupled to the system, and the system being configured to adjust the luminance on the HUD based on sensed information from the light sensor.

6. The system according to claim 5, wherein the light guide includes a reflective surface introduced at a portion of the transparent panel not exposed by the housing portion.
